(19) United States
(12) Patent Application Publication
(10) Pub. No.: US 2003/0006107 A1
(43) Pub. Date: Jan. 9, 2003

(54) Disk for use with a brake system

(76) Inventor: Ming-Ta Tsai, Taipie Hsien (TW)

Correspondence Address: Cooper & Dunham LLP, 1185 Avenue of the Americas, New York, NY, 10036, US

(21) Appl. No.: 09/888,956

(22) Filed: Jun. 25, 2001

(51) Int. Cl. F16D 65/12

(52) U.S. Cl. 188/218 XL

(57) ABSTRACT

A disk device for use with a brake system has a central bore, an annular peripheral area adjacent to the outer peripheral edge of the disk. The annular peripheral area is concentric with the central bore and has an inner edge opposite the outer peripheral edge of the disk. The annular peripheral area is provided with multiple through-bores, notches through-holes in the inner edge of the annular peripheral area. Accordingly, these through-bores, notches and through-holes will scrape off all contaminants from side faces of the brake pads and the brake pads are able to be worn in an even manner and the braking effect is improved because of the even wear of the brake pads.

### BACKGROUND OF THE INVENTION

1. Field of the Invention

The present invention relates to a disk for use with a brake system, and more particularly to a disk having multiple through-bores and through-holes extended both side faces of the disk and multiple notches in an outer periphery of the disk, which are able to remove dirt and moisture from the surface of both brake pads in contact with the disk. Thus, the brake pads can be worn off in an even manner and the braking effect can be improved because of even wear of the brake pads.

2. Description of Related Art

A conventional brake system has a disk and a pair of brake shoes. Each of the brake shoes is further equipped with a brake pad on the face facing to both sides of the disk. The friction between the disk and the pair of brake pads will provide sufficient resistance to produce the braking effect. In general, the disk and the pair of brake shoes of a brake system are exposed in the open air, and will gradually become dusty, damp and be covered with strange matter on their surface, which results in a series of problems that substantially shorten the life span of the brake pads and also reduce the braking effect because of uneven wear of brake pads.

In order to minimize strange matter and moisture on the surface of disk and the heat through friction between disk and brake pads, the customary disks are equipped with holes. These holes of the conventional disk will serve to dissipate heat more easily. Originally these holes are only designed to dissipate heat from the engagement between the disk and the brake pads and to enhance the cleaning process when the brake pads engage with the disk. However, the holes cause uneven wear to the faces of the brake pads engaging with the disk, which greatly shorten the life span of the brake shoes.

The present invention introduces a disk that is able to obviate and/or mitigate above-mentioned problems of the conventional brake disk.

### SUMMARY OF THE INVENTION

The main objective of the invention is to provide a disk having multiple through-bores, notches and through-holes in the side surface and outer periphery of the disk, which is able to take dust, strange matter and moisture away from the surface of the brake pads.

In order to achieve the foregoing objective, the disk in accordance with the present invention has a central bore, an annular peripheral area adjacent to the outer peripheral of the disk. The through-bores are defined with equally spacing in the annular peripheral area of the disk and extend through both side faces of the annular peripheral area. The notches are defined in an outer periphery edge of the disk and the through-holes extend through both side faces of the annular peripheral area adjacent to the inner edge of the annular peripheral area. The through-bores are accordingly equipped to scrape off most of dirt and moisture from the brake pads. The notches and through-holes are accordingly provided to take the rest of the dirt and moisture away from the brake pads.

Other objects, advantages and novel features of the invention will become more apparent from the following detailed description when taken in conjunction with the accompanying drawings.

### BRIEF DESCRIPTION OF THE DRAWINGS

The present invention will now be better understood with reference to the following drawings, wherein:

FIG. 1 is a plane view showing the structure of the disk device of the present invention;

FIG. 2 is an enlarged view of the disk device with the brake pad of the brake shoe applied to the annular peripheral area where the through-bores, through-holes and notches are defined; and

FIG. 3 to FIG. 5 are operational side plan views showing the engagement between the brake pads and the disk device, wherein the disk device is in section for the purpose of clarity.

### DETAILED DESCRIPTION OF THE PREFERRED EMBODIMENT

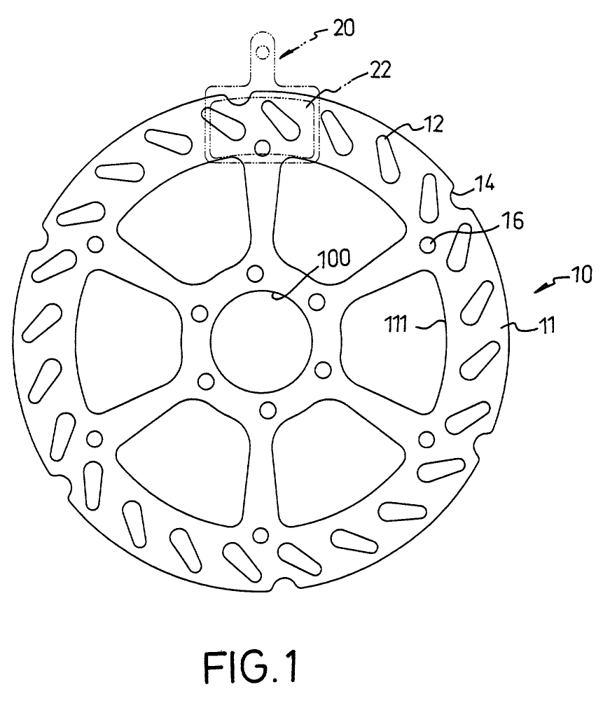

With reference to FIG. 1, the disk device (10) in accordance with the present invention defines a central bore (100), an annular peripheral area (11) adjacent to the outer peripheral edge of the disk device (10). The annular peripheral area (11) has an inner edge (111) and defines therein multiple through-bores (12), notches (14) and through holes (16).The through-bores (12) each are equally spaced apart from each other in the annular peripheral area (11). The through-holes (16) are equiangularly defined in the inner edge (111) of the annular peripheral area (11) and the notches (14) are also equiangularly defined in the outer peripheral edge of the disk device (10). With such an arrangement, it is noted that one through hole (16) and one notch (14) are defined between two through bores (12). The through-bores (12) and the through-holes (16) extend through side faces of the annular peripheral area (11). The through-holes (16) each are equally spaced apart from each other and the notches (14) each are equally spaced apart from each other. According to above-mentioned structure of the annular peripheral area (11), the cross section of the annular peripheral area (11) is completely covered by the arrangement of through-bores (12), notches (14) and through-holes (16) wherever the through-bores (12), notches (14) and through-holes (16) are defined.

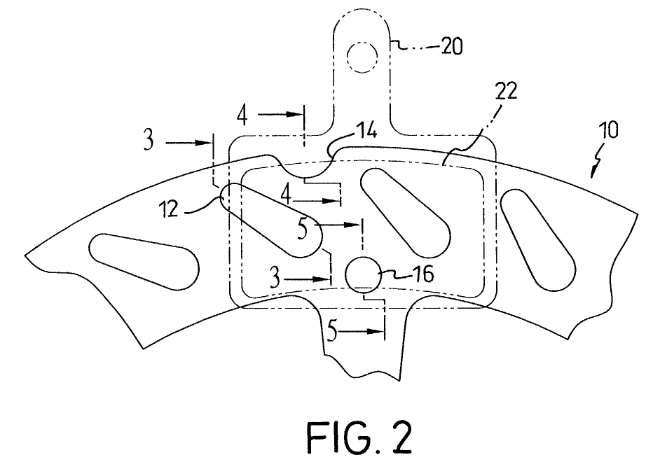

With reference to FIG. 2, the structure of two brake shoes (20) used on both sides of the disk device (10) is the same as conventional disk brake system. Each of the pair of brake shoes (20) is equipped with a brake pad (22) on the surface facing to the disk device (10). When the brake shoe (20) with the brake pad (22) shown in phantom lines in FIG. 2 engages the disk device (10), the annular peripheral area (11) of the disk device (10) is able to completely cover the entire area of the brake pad (22).

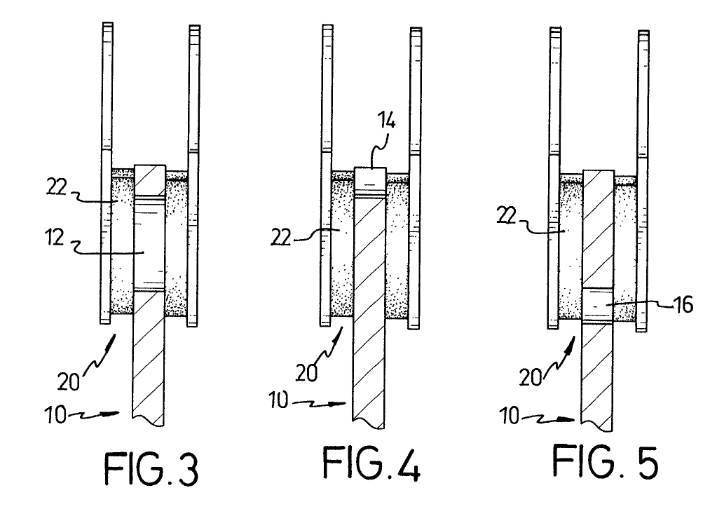

With reference to FIGS. 3 to 5, the through-bores (12) are accordingly equipped to scrape off most of contamination from the brake pads (22), and the notches (14) and the through-holes (16) are accordingly provided to take the rest of dirt and moisture away from the brake pads (22). With the result that the engagement between the brake pads (22) and the disk device (10) of the present invention, the disk device (10) is able to provide even wear to the brake pads (22) let alone the enhancement effect in cleaning of the brake pads (22).

From the foregoing, it is seen that the objects mentioned before set forth may readily and efficiently be attained, and since certain changes may be made in the above construction and different embodiments of the invention be implemented without departing from the scope thereof. It is intended that all matter contained in the above description or shown in the accompanying drawings shall be interpreted as illustrative and not in limiting sense.

What is claimed is

1. A disk device for use with a brake system, the disk device comprising:
a disk having a central bore, an outer peripheral edge and an annular peripheral area adjacent to the outer peripheral edge of the disk, the annular peripheral area having an inner edge and defining therein multiple through-bores, notches and through-holes, wherein the improvements comprising:
the through-bores each are equally spaced apart from each other in the annular peripheral area,
the through-holes are defined in the inner edge of the annular peripheral area, and the through-bores and the through-holes extend through side faces of the annular peripheral area,
the notches are defined in the outer peripheral edge of the disk, and each are equally spaced apart from each other.

2. The disk device for use with a brake system as claimed in claim 1, wherein the sequence of the respective equally arranged through-bores, notches and through-holes is able to completely cover the cross section of the annular peripheral area.

3. The disk device for use with a brake system as claimed in claim 2, wherein each of the notches and the through-holes are equiangularly defined in the disk and are arranged between two through-bores in the annular peripheral area.
